(19) United States
(12) Patent Application Publication
(10) Pub. No.: US 2009/0027348 A1
(43) Pub. Date: Jan. 29, 2009

(54) Interactive wireless control system

(76) Inventors: Yen-Ruey Li, Taipei (TW); Ching-Hsiang Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/878,470

(22) Filed: Jul. 25, 2007

(51) Int. Cl. G09G 5/00

(52) U.S. Cl. 345/172

(57) ABSTRACT

An interactive wireless control system includes a control module and an application system. The control module includes a microprocessor having an image processing unit and a plurality of connecting interfaces. The control module is applied to a remote control device having at least one image-obtaining unit so that the microprocessor uses the connecting interfaces to control the remote control device. The application system is wirelessly connected with the control module to perform wireless signal transmission. The application system receives a live image signal transmitted by the remote control device and displays the live image signal, and generates an operating control signal to the microprocessor to control the remote control device. Thereby, the functions of the interactive wireless control system can be increased.

### BACKGROUND OF THE INVENTION

1. Field of the Invention

The present invention relates to a wireless control system. In particular, this invention relates to a wireless control system that uses wireless transmission technology to interact with a controlled device.

2. Description of the Related Art

Wireless remote control systems of the prior art are usually designed with RF. However, the controlling distance of RF wireless remote control systems is limited. The user can only control the controlled device, which can be seen by the user via a wireless method. Thereby, the functions of the wireless control system that are designed by the prior art method are limited. For example, when the controlled device/is located in a location that the user cannot see, or is moved to another area, the user cannot control the device easily.

Furthermore, by using the remote controlling method of the prior art, a large amount of data (such as images or sounds) cannot be transmitted between the remote controller and the controlled device. Therefore, the user can only use the remote controller to perform simple operations. The functions of the wireless control system that are designed by the prior art are limited. They do not meet the requirements of devices having multiple functions and being versatile.

How to design and improve wireless control systems so that they can have multiple functions and be versatile, or to achieve an interactive effect is a problem in need of a solution. How to easily integrate wireless control systems with a variety of devices to allow wireless control is yet another.

### SUMMARY OF THE INVENTION

One particular aspect of the present invention is to provide an interactive wireless control system. The present invention uses a simple hardware circuit to easily integrate the wireless control system with the controlled device. The user can use the software application in the application system and use the wireless network transmission technology to control the controlled device, and transmit and receive data between both to achieve an interactive effect. Furthermore, the user can wirelessly control the controlled device without having it in his or her line of sight. The user can use a remote application system to control the controlled device when the user is located near the controlled device. Therefore, the wireless control system can be applied to a variety of devices to achieve different functions.

The interactive wireless control system includes a control module and an application system. The control module is located on a remote control device having at least one image-obtaining unit, and further includes a wireless receiving and sending unit and a microprocessor. The microprocessor has a plurality of universal serial buses and a plurality of general purpose input/output pins to connect to the remote control device. Thereby, the microprocessor can control the remote control device according to an operating control signal. One of the universal serial buses is connected with the image-obtaining unit so that the microprocessor can receive a live image signal obtained by the image-obtaining unit. The microprocessor is electrically connected with the wireless receiving and sending unit to transmit a wireless signal via the wireless receiving and sending unit. The application system is connected with the control module by a wireless method to perform wireless signal transmission with the wireless receiving and sending unit of the control module. Thereby, the application system receives live image signals and displays the live image signals, and further generates the operating control signal to control the remote control device.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1A is a block diagram of the interactive wireless control system of the present invention;

FIG. 1B is a block diagram of the interactive wireless control system of the embodiment of the present invention;

FIG. 2 is a look up table for the operating interface and the operating program of the interactive wireless control system of the present invention; and

FIG. 3 is a schematic diagram of the interactive wireless control system of the embodiment of the present invention.

### DETAILED DESCRIPTION OF THE PREFERRED EMBODIMENTS

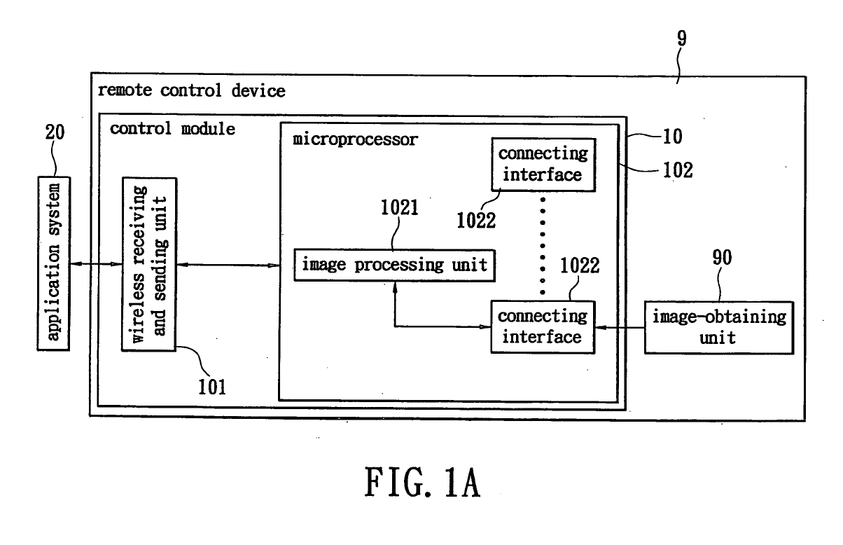

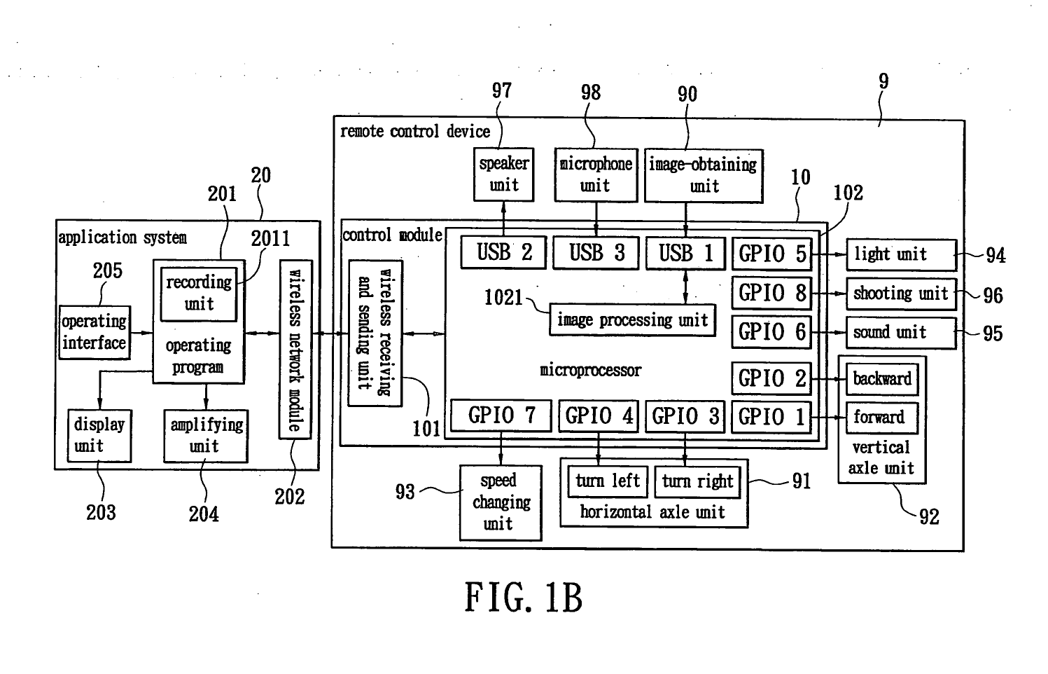

Reference is made to FIGS. 1A and 1B, which show a block diagram of the interactive wireless control system of the embodiment of the present invention and a block diagram of the interactive wireless control system of the embodiment of the present invention. The interactive wireless control system includes a control module 10 and an application system 20. The control module 10 cooperates with a remote control device 9 having at least one image-obtaining unit 90 to control the remote control device 9. The application system 20 is used as a control interface for the user to control the remote control device 9, and uses wireless signal transmission technology to communicate with the remote control device 9 and transmit an operating control signal to the control module 10. The image-obtaining unit 90 can obtain a live image signal that shows the location of the remote control device 9 and the captured angle of the remote control device 9. Therefore, when the user transmits the live image signal to the application system 2 via wireless signal transmission, the user can observe the live image signal displayed by the application system 20 to control the remote control device 9. The user feels that he is located near the remote control device 9 to control the remote control device 9. The remote control device 9 can be applied to a remote control toy car, a construction car, a lifesaving device, or a portable monitoring device. The wireless signal transmission technology can be WiFi, 3G, or UWB.

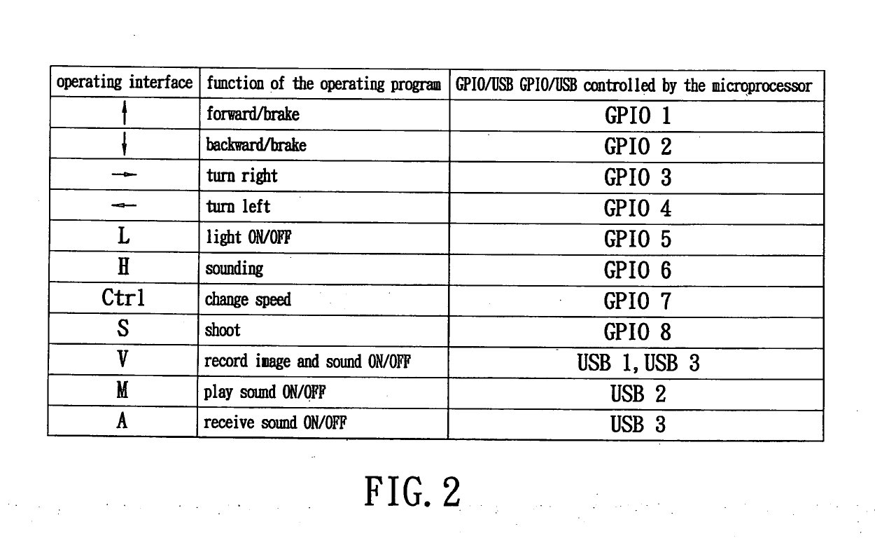

The control module 10 includes a wireless receiving and sending unit 101, and a microprocessor 102. The microprocessor 102 includes an image processing unit 1021 and a plurality of connecting interfaces 1022. The plurality of connecting interfaces 1022 can be the universal serial buses USB1˜3 and the general purpose input/output pins GPIO1˜8, as shown in FIG. 2. The microprocessor 102 is electrically connected with the wireless receiving and sending unit 101 to receive or send signals via the wireless receiving and sending unit 101 via wireless signal transmission.

The universal serial buses 1˜3 and the general purpose input/output pins 1˜8 of the microprocessor 102 are respectively connected with the different functional units in the remote control device 9. Thereby, the microprocessor 102 controls the remote control device 9 according to an operating control signal. As shown in the FIG. 1B, the functional units of the remote control device 9 include the image-obtaining unit 90, a horizontal axle unit 91, a vertical axle unit 92, a speed changing unit 93, a light unit 94, a sound unit 95, a shooting unit 96, a speaker unit 97, and a microphone 98. The microprocessor 102 uses the horizontal axle unit 91 and the vertical axle unit 92 to control the movement of the remote control device 9 according to the operating control signal. The horizontal axle unit 91 is connected with two general purpose input/output pins GPIO3, GPIO4 of the microprocessor 102 to control the remote control device 9 to move right or left. The vertical axle unit 92 is connected with two general purpose input/output pins GPIO1, GPIO2 of the microprocessor 102 to control the remote control device 9 to move forwards or backwards.

In one embodiment, the speed changing unit 93 is connected with the general purpose input/output pin GPIO1 of the microprocessor 102 so that the microprocessor 102 changes the speed of the remote control device 9 according to the operating control signal. The microprocessor 102 controls the general purpose input/output pin GPIO1 to adjust the current to change the speed.

The light unit 94, the sound unit 95 and the shooting unit 96 are respectively connected with the general purpose input/output pins GPIO5, GPIO6, GPIO8 of the microprocessor 102 so that microprocessor 102 controls the remote control device 9 to turn on a light, sound an alarm, or shoot according to the operating control signal.

After the microprocessor 102 receives the operating control signal, it can immediately control the functional units without having to receive a large amount of data.

The universal serial buses USB1˜3 of the microprocessor 102 are connected with the image-obtaining unit 90, the speaker unit 97, and the microphone 98. Because the image-obtaining unit 90, the speaker unit 97 and the microphone 98 have to transmit image data or sound data, the image-obtaining unit 90, the speaker unit 97, and the microphone 98 respectively are connected with the universal serial buses USB1, USB2, USB3. The image-obtaining unit 90 is used for obtaining the live image signal of the remote control device 9 so that the microprocessor 102 can receive the live image signal and processes it via the image processing unit 1022. Next, the microprocessor 102 uses the wireless receiving and sending unit 101 to transmit the image signal to the application system 20, and the user can observe it.

The speaker unit 97 is used for outputting a sound signal. The sound signal is a pre-determined sound signal that is transmitted by the application system 20 via wireless signal transmission and played by the microprocessor 102, or a real-time sound signal. The pre-determined sound signal is a sound signal that is stored in the application system 20 (such as an audio file or a sound file). The real-time sound signal is a sound signal inputted by the user via the application system 20 (such as the user's actual voice).

The microprocessor 102 uses the microphone 98 to receive the live sound signal of the remote control device 9 and transmits the live sound signal to the application system 20 via wireless signal transmission. Thereby, the application system 20 can receive both the live image signal and the live sound signal obtained by the remote control device 9 so that the user feels he/she is located at near the remote control device 9. Furthermore, when the user operates both the microphone unit 98 and the speaker 97, the user can talk to the person located near the remote control device 9 via the application system 20 to achieve an interactive feel.

The application system 20 includes an operating program 201, a wireless network module 202, a display unit 203, an amplifying unit 204, and an operating interface 205. The application system 20 is a desktop PC, a laptop, a cell phone, a PDA, or a portable digital game machine, etc. The application system 20 is connected with the control module 10 via the wireless network module 202 via a wireless method to perform wireless signal transmission with the wireless receiving and sending unit 101. According to one method, the application system 20 generates the operating control signal to control the remote control device 9. Alternatively, the application system 20 receives the data signals transmitted by the control module 10.

The operating program 201 is connected with the operating interface 205 and the wireless network module 202. The operating interface 205 is the keyboard, a rocking rod, or a curser device that controls the operating program 201 to make the operating program 201 generate the operating control signal and transmit the operating control signal to the control module via the wireless network module 202. Alternatively, the operating program 201 receives the live image signal and the live sound signal transmitted by the control module 10, and displays the live image signal and plays the live sound signal via the display unit 203 and the amplifying unit 204. The function of the interactive wireless control system is therefore versatile. The operating program 201 can further including a recording unit 2011 to record and store the live image signals and the live sound signals when the display unit 203 and the amplifying unit 204 output the live image signal and the live sound signal.

Reference is made to FIG. 2, which shows a look up table for the operating interface and the function of the operating program of the interactive wireless control system of the present invention. In this embodiment, the operating interface is a computer keyboard. The user can set the buttons and the corresponding functions of the operating program 201. Next, the operating program 201 outputs the operating control signal to the control module 10 of the remote control device 9 according to the button pressed by the user so that the microprocessor 102 of the control module 10 controls the remote control device 9. As shown in FIG. 2, the microprocessor 102 controls the functional units connected by the different general purpose input/output pins GPIO1˜8 and the different universal serial buses USB1˜3 according to the different operating control signals. Alternatively, the microprocessor 102 can control the plurality of corresponding functional units according to one operating control signal. For example, when the microprocessor 102 receives the operating control signal “V” to record the image and the sound, the microprocessor 102 controls the image-obtaining unit 90 and the microphone unit 98 via the USB 1 and the USB 3 to receive the live image signals and the live sound signals and transmit the live image signals and the live sound signals to the application system 20 and store the signals.

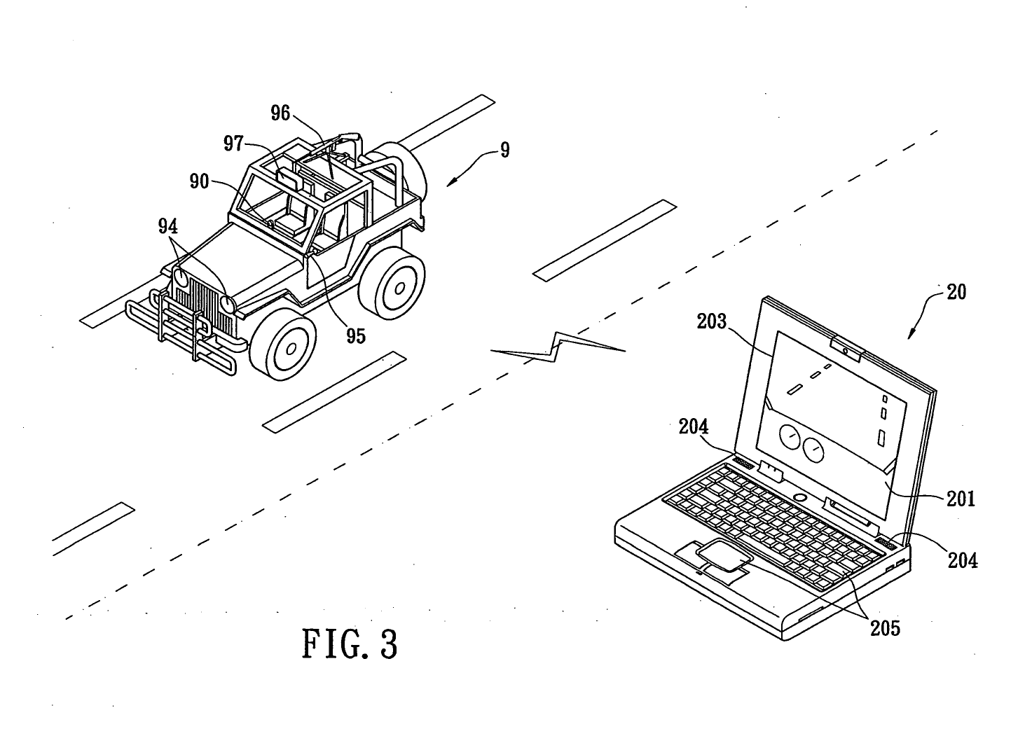

Reference is made to FIG. 3, which shows a schematic diagram of the interactive wireless control system of the application embodiment of the present invention. In this embodiment, the remote control device 9 is a remote control toy car. The remote control toy car has an image-obtaining unit 90, a light unit 94, a sound unit 95, a shooting unit 96, and a speaker unit 97. The control module 10 for controlling these functional units is located in the interior of the remote control toy car (not shown in the Figure). After the user executes the operating program 201 in the application system 20, the user uses the display unit 203 to observe the live image signals transmitted by the remote control device 9 and uses the operating interface 205 to control the remote control device 9. The operating method is the same as the buttons and the corresponding functions as shown in FIG. 2.

The interactive wireless control system of the present invention integrates wireless transmission technology that can transmit a large amount of data. It also uses modulated hardware so that the interactive wireless control system can be applied to a variety of devices that need a remote control. Because the modulated hardware uses the universal serial bus and the general purpose input/output pins as the interface, the function of the interactive wireless control system can be expanded easily. The present invention transmits the real time image to achieve the reality effect so that the interactive wireless control system is suitable for a variety of fields and can perform a variety of functions.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An interactive wireless control system, comprising:
a control module applied to a remote control device having at least one image-obtaining unit, wherein the control module comprises:
a wireless receiving and sending unit for performing wireless signal transmission; and
a microprocessor for controlling the operation of the wireless receiving and sending unit, wherein microprocessor includes an image processing unit and a plurality of connecting interfaces so that the microprocessor controls the remote control device according to an operating control signal;
wherein one of the connecting interfaces is connected with the image-obtaining unit and the image processing unit receives a live image signal obtained by the image-obtaining unit; and
an application system connected with the control module in a wireless method for performing a wireless signal transmission with the wireless receiving and sending unit, the application system receives the live image signal and displays the image signal in real time, and generates the operating control signal to control the remote control device.

2. The interactive wireless control system as claimed in claim 1, wherein the remote control device is a remote control toy car, a construction car, a lifesaving device, or a portable monitoring device.

3. The interactive wireless control system as claimed in claim 1, wherein the wireless signal transmission technology is WiFi, 3G, or UWB.

4. The interactive wireless control system as claimed in claim 1, wherein the connecting interfaces are universal serial buses and/or general purpose input/output pins.

5. The interactive wireless control system as claimed in claim 1, wherein the remote control device further comprises a horizontal axle unit, a vertical axle unit, a speed changing unit, a light unit, a sound unit, and a shooting unit, and these units are respectively connected with the connecting interfaces of the microprocessor and are controlled by the operating control signal.

6. The interactive wireless control system as claimed in claim 5, wherein the horizontal axle unit and the vertical axle unit are respectively connected with two connecting interfaces so that the horizontal axle unit controls the remote control device to move right or left, and the vertical axle unit controls the remote control device to move forwards or backwards.

7. The interactive wireless control system as claimed in claim 5, wherein the microprocessor controls a current to change the speed of the speed changing unit.

8. The interactive wireless control system as claimed in claim 1, wherein the remote control device further comprises a speaker connected with the connecting interface for receiving and outputting a sound signal transmitted by the microprocessor.

9. The interactive wireless control system as claimed in claim 8, wherein the sound signal is a pre-determined sound signal transmitted from the application system to the microprocessor, or a real time sound signal.

10. The interactive wireless control system as claimed in claim 8, wherein the remote control device further comprises a microphone unit connected with the connecting interface for receiving a live sound signal and transmitting the sound signal to the microprocessor, and the microprocessor uses the wireless signal transmission to transmit the live sound signal to the application system.

11. The interactive wireless control system as claimed in claim 10, wherein the application system further comprises:
an operating program for receiving the live image signal and the live sound signal;
a display unit connected with the operating program for displaying the live image signal; and
an amplifying unit connected with the operating program for playing the live sound signal.

12. The interactive wireless control system as claimed in claim 11, wherein the operating program has a recording unit for recording and storing the live image signal and the live sound signal.

13. The interactive wireless control system as claimed in claim 11, wherein the application system further includes an operating interface, and the operating interface is used for controlling the operating program to make the operating program generate the operating control signal.

14. The interactive wireless control system as claimed in claim 13, wherein the operating interface is a keyboard, a rocking rod, or a curser device.

15. The interactive wireless control system as claimed in claim 11, wherein the application system comprises a wireless network module connected with the operating program and wirelessly connected with the wireless receiving and sending unit to perform wireless signal transmission.

16. The interactive wireless control system as claimed in claim 1, wherein the application system is a desktop computer, a laptop, a cell phone, a PDA, or a portable digital game machine.
